(19) United States
(12) Patent Application Publication
(10) Pub. No.: US 2012/0237912 A1
(43) Pub. Date: Sep. 20, 2012

(54) 12-LEAD ELECTROCARDIOGRAM ONLINE-LEARNING SYSTEM

(75) Inventors: JUI-CHIEN HSIEH, Taoyuan County (TW); KUO-CHIANG YU, Taoyuan County (TW); CHEN-YUN LIU, Taoyuan County (TW); CHUNG-CHI YANG, Taoyuan County (TW); PEI-CHANN CHANG, Taoyuan County (TW)

(73) Assignee: YUAN ZE UNIVERSITY, Taoyuan County (TW)

(21) Appl. No.: 13/401,556

(22) Filed: Feb. 21, 2012

(30) Foreign Application Priority Data
Mar. 18, 2011 (TW) 100109405

(51) Int. Cl. G09B 23/28

(52) U.S. Cl. 434/262

(57) ABSTRACT

The present invention relates to an E-learning system for 12-lead electrocardiogram (ECG), comprising a processing server with a plug-in browser for receiving electrocardiogram-related data and eliminating noise accompanied in the electrocardiogram-related data; a learning database apparatus for storing the electrocardiogram-related data; and a learning network server for accessing the electrocardiogram-related data via network communication.

### FIELD OF THE INVENTION

The present invention relates to an E-learning system for 12-lead electrocardiogram (ECG).

### DESCRIPTION OF PRIOR ART

1. Patents

In these days, inventors have been working hard on developing the learning of 12-lead electrocardiogram interpretation to an E-learning, and expanding the learning range to on-line interactive learning according to the following patents: Taiwan patent published number M374095 [symbol] I272514 [symbol] I291670 [symbol] M376835 [symbol] I288898 [symbol] I275047 [symbol] I257592 and I460820, and Taiwan application published number 200923860 and 200908618. Thus, it is desired to develop a system to allow users viewing the 12-lead electrocardiograms and on-line discussing in real time, in which the system could be executed directly on a mobile apparatus without space limitation, such that the learners could study at any time.

2. Academic Research Reports

The electrocardiogram is usually an essential and elementary research procedure to diagnosis the heart disease, while the students of the medical school wish to take more courses for interpreting the electrocardiogram. However, the preceptors have insufficient time to the required support to the students. (Jorge G. Ruiz, Michael J. Mintzer, MD, and Rosanne M. Leipzig, MD, PhD, The Impact of E-Learning in Medical Education.2006).

However, there are a lot of ways of learning, and on-line learning is one of the ways. In the integrated development plan, it is confirmed that combining on-line learning and medical education is beneficial. Self-learning and co-working of the students could be encouraged, and the quality of teaching and learning could also be raised through the on-line learning. (Adhi Susilo, USE OF FACEBOOK FOR ACADEMIC NETWORK LEARNING IN UNIVERSITAS TERBUKA—INDONESIA, 2008) The key factors that affect social network learning are: cooperative and close interaction, an interesting environment, a continuous learning environment, and Facebook does have such advantages. (Kale,Ugur. and Bryant, J. Alison. Applications of Social Network Analysis in an Online Forum of Teachers. 2009).

Besides, the network intensity, cohesiveness, centrality and concentration could be calculated by a social network analysis method. The data of discussing and learning, either between the students or students and their teachers, on the present e-learning system regarding the learning data is used to analyze the interaction condition of students and expressed as learning performance parameters. These learning performance parameters can be used to estimate students' learning condition by teachers.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a structural diagram of the present invention.

FIG. 2 illustrates a Silverlight electrocardiogram.

FIG. 3 illustrates a zoomed-in electrocardiogram.

FIG. 4 illustrates a zoomed-out electrocardiogram.

FIG. 5 illustrates measuring slope of electrocardiogram.

FIG. 6 illustrates horizontally measuring electrocardiogram.

FIG. 7 illustrates vertically measuring electrocardiogram.

FIG. 8 illustrates an electrocardiogram discussing forum.

FIG. 9 illustrates replies in electrocardiogram discussing forum.

FIG. 10 illustrates a NodeXL community analysis tool.

FIG. 11 illustrates a social network diagram.

FIG. 12 illustrates result of analysis of social network.

FIG. 13 illustrates a NodeXL analysis result value.

### SUMMARY OF THE INVENTION

The present invention discloses a 12-lead ECG online-learning system, which comprises a processing server with a plug-in browser for receiving electrocardiogram-related data and eliminating a noise accompanied in the electrocardiogram-related data, wherein the plug-in browser is a Microsoft Silverlight browser, and the browser could eliminate the noise of the electrocardiogram-related data, and the electrocardiogram-related data is an electrocardiogram or electrocardiogram-related information, and the format of the electrocardiogram is an XAML format; a learning database apparatus for storing the electrocardiogram-related data in the learning database apparatus; a learning network server for accessing the electrocardiogram-related data via network communication; and a social network analyzing utility software for analyzing the electrocardiogram-related data.

### DETAILED DESCRIPTION OF THE INVENTION

The object of the present invention is constructing an E-learning environment on FACEBOOK of the community website, so as to encourage students self-learning and raise the learning performance through the interactive cooperation. The present invention also provides a social network analysis to allow students to understand his/her learning condition, and also to know the other students' learning condition to help each other.

There are at least three improvements of the present invention as compared with the prior art:
First, the 12-lead electrocardiogram could be provided on the network via the Microsoft Siliverlight technique, and the electrocardiogram could be zoomed in and zoomed out without distortion; the vertical height, horizontal distance, frequency and the slope of the wave of the electrocardiogram could also be measured on-line.
Second, in the internet community, such as Facebook, the discussing forum of the 12-lead electrocardiogram could be established by users. Via case study, users could discuss their observation results on the internet community.
Third, in the internet community such as Facebook, users could obtain the social network analysis via the case study of 12-lead electrocardiogram, and the discussion file of the discussed case could be downloaded by users to further analyze the file by NodeXL to execute social network analysis, so as to understand the learning situation and position on the network instantaneously.

The present invention discloses a 12-lead ECG online learning system, which comprises: a processing server with a plug-in browser for receiving electrocardiogram-related data and eliminating noise accompanied in the electrocardiogram-related data, wherein the plug-in browser is a Microsoft silverlight browser, and the browser could elimate the noise of the electrocardiogram-related data, and the electrocardiogram-related data is an electrocardiogram or electrocardiogram-related information, and a format of the electrocardiogram-related data is an XAML format; a learning database apparatus for storing the electrocardiogram-related data in the learning database apparatus; a learning network server for accessing the electrocardiogram-related data via a network communication, wherein the learning network server can transfer the electrocardiogram-related data through the electrocardiogram managing system or the website interface; and a social network analyzing utility software for analyzing the electrocardiogram-related data.

The 12-lead ECG online-learning system of the present invention further comprises an electrocardiogram managing system for selecting the electrocardiogram-related data with exploratory or meaningfulness, and then transferring the electrocardiogram-related data to the Microsoft Silverlight browser.

The 12-lead ECG online-learning system of the present invention further comprises a community website, wherein the community website is Facebook, and a user uses the community website to log in the 12-lead ECG online-learning system, wherein the community website comprises a network interface, and the user is a teacher, a student, a clinical staff or a patient.

The 12-lead ECG online-learning system of the present invention observes the electrocardiogram-related data by using a horizontal tool, a vertical tool, a slope tool or a cleaning tool of the website interface, and further analyzes the electrocardiogram-related data via the social network analysis tool software (NodeXL) and EXECEL 2007.

With these and other objects, advantages, and features of the invention that may become hereinafter apparent, the nature of the invention may be more clearly understood by reference to the detailed description of the invention, the embodiments and to the several drawings herein.

### EXAMPLE

Exemplary embodiments of the present invention are described herein in the context of an illuminating system and a method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

1. Program logic

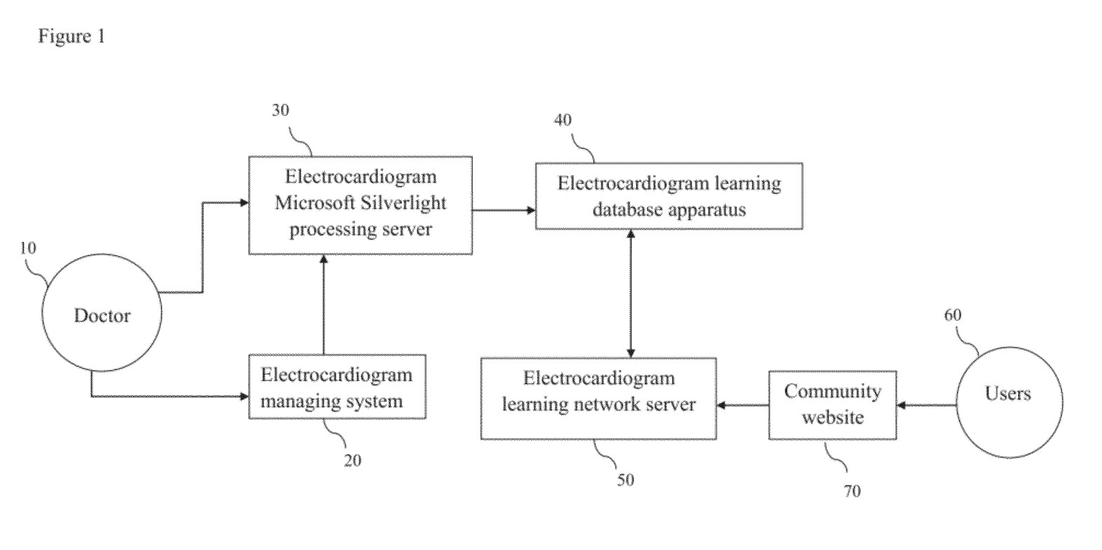

A development structure of the present invention is shown in FIG. 1. A doctor 10 could use the function which was provided by an electrocardiogram management system 20 of present invention that uploads the electrocardiogram to a learning platform. The electrocardiogram managing system 20 would select the electrocardiogram with exploratory or meaningfulness, and then transfer the electrocardiogram to a processing server 30, provided with a plug-in browser, such as a Microsoft Silverlight browser. Generally, the electrocardiogram was obtained clinically by an ECG machine which contains the 12-lead electrocardiogram wave signal with noise, and the processing server 30 would eliminate the noise and store the electrocardiogram into the database. Except through the electrocardiogram managing system 20, the present invention further provided another way for uploading, that is, through the website connected with a processing server 30. The system would execute the same process (eliminate the noise) and transfer the electrocardiogram to an electrocardiogram learning database apparatus 40.

After coding the processed electrocardiogram-related data by the Microsoft Silverlight browser with an XAML file, the electrocardiogram of the Silverlight technique browser was shown through discussing forum of an electrocardiogram learning network server 50, and the discussing forum was opened to provide users 60 for instantly interacting. In order to facilitate users to use the system of the present invention, the system of the present invention was constructed on a community website Facebook 70, so the clinical staff or students could proceed with discussion on the discussing forum website with their classmates, friends or teachers, and moreover could get concerns or teaching from other experts through the open community website.

2. Operation flow

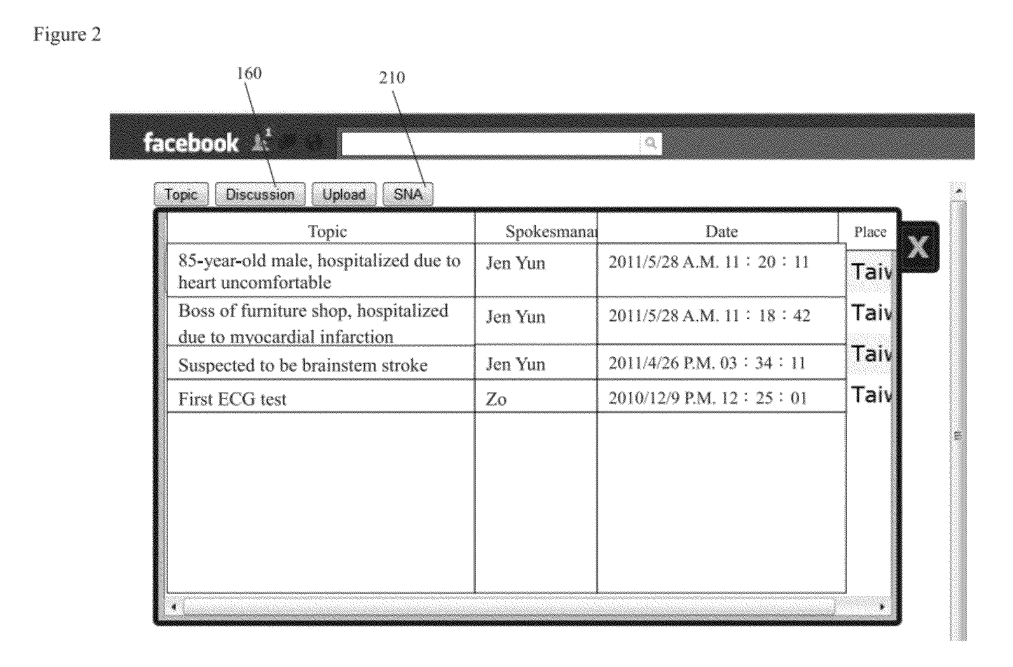

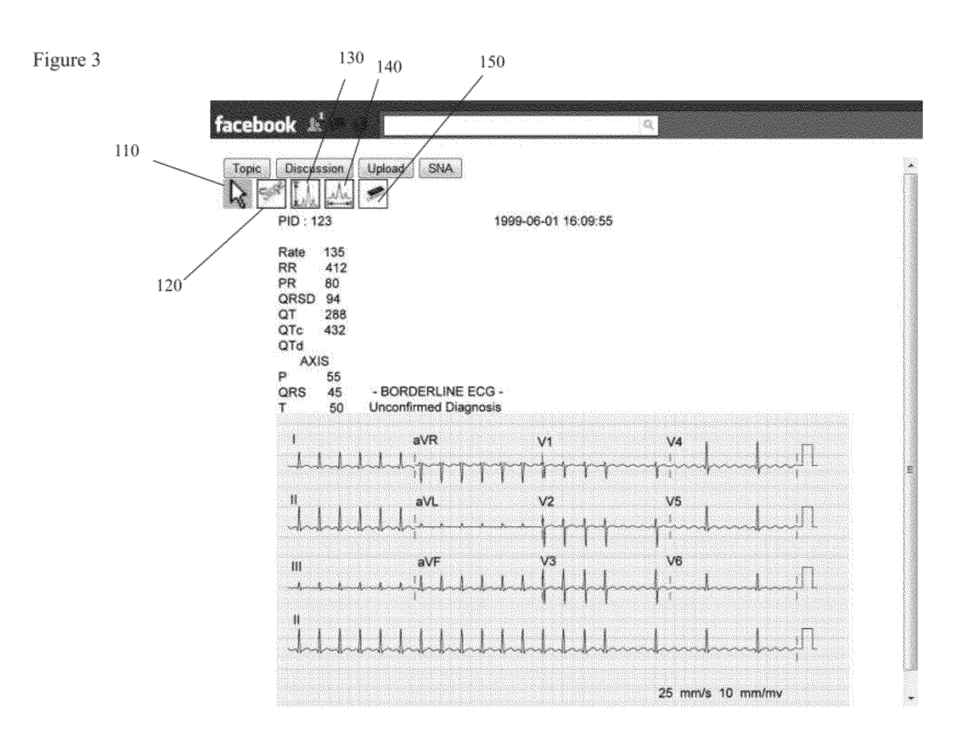

The present invention was capable of constructing the electrocardiogram of learning application program on the Facebook. While the learning application program was executed, the system would display the discussing topics right now for users to choose, as shown in FIG. 2. Users could select the topics to start learning. After clicking the topic, the system would display the electrocardiogram-related data automatically, and users only needed to click “x” to close the topic and then could observe the electrocardiogram, as shown in FIG. 3.

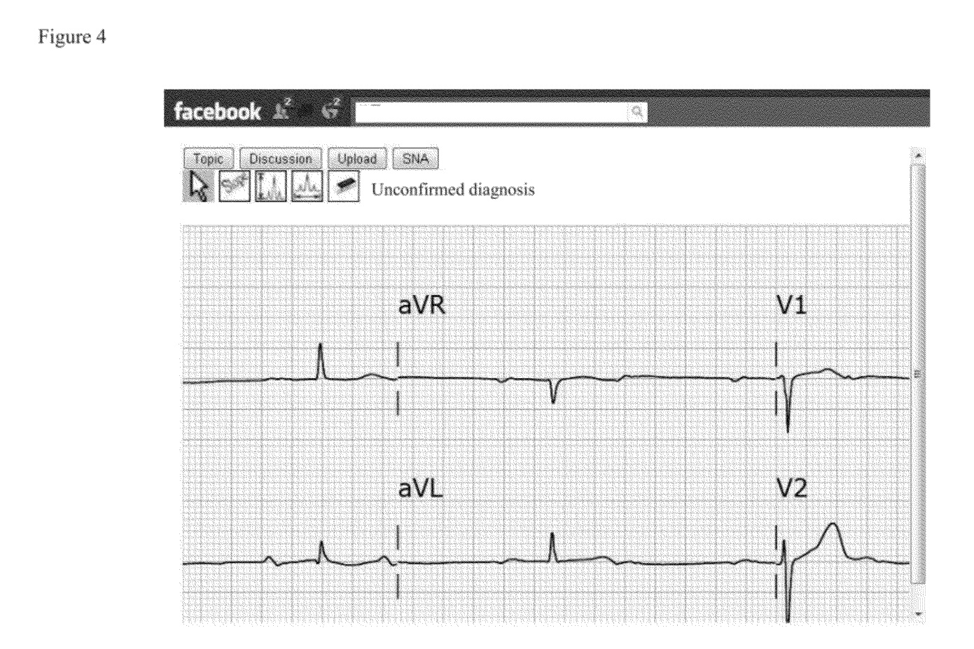

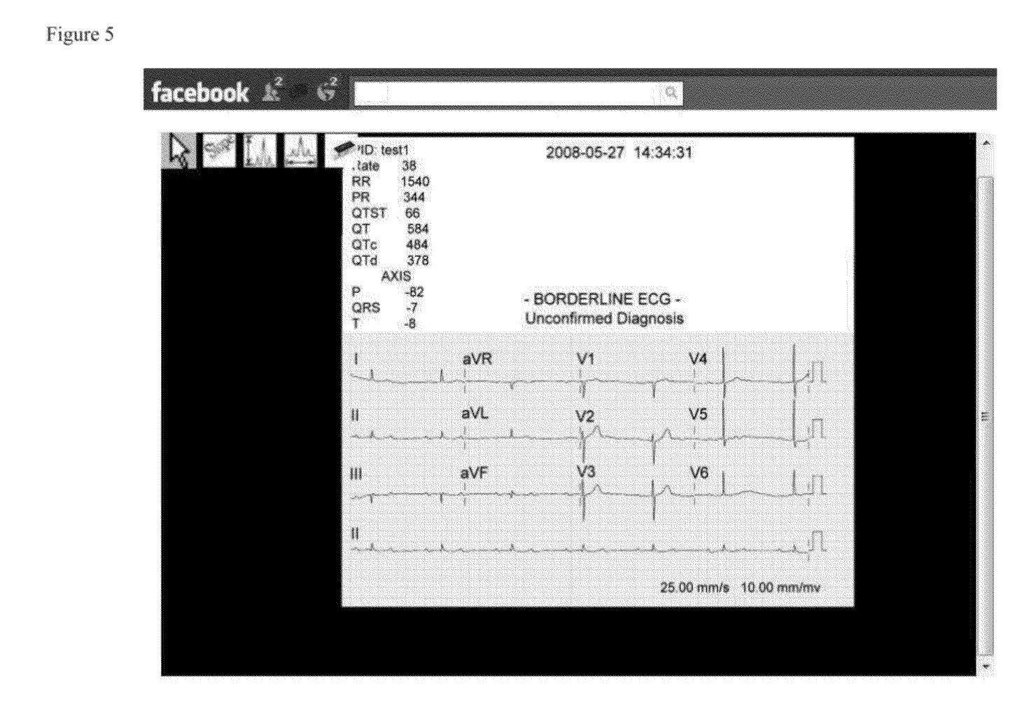

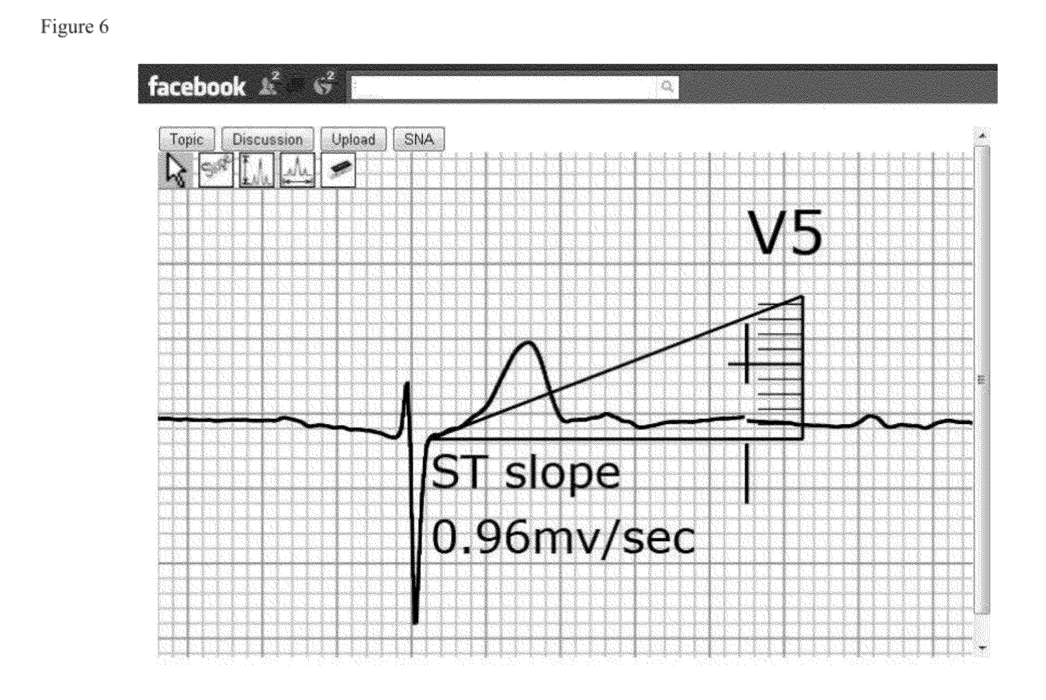

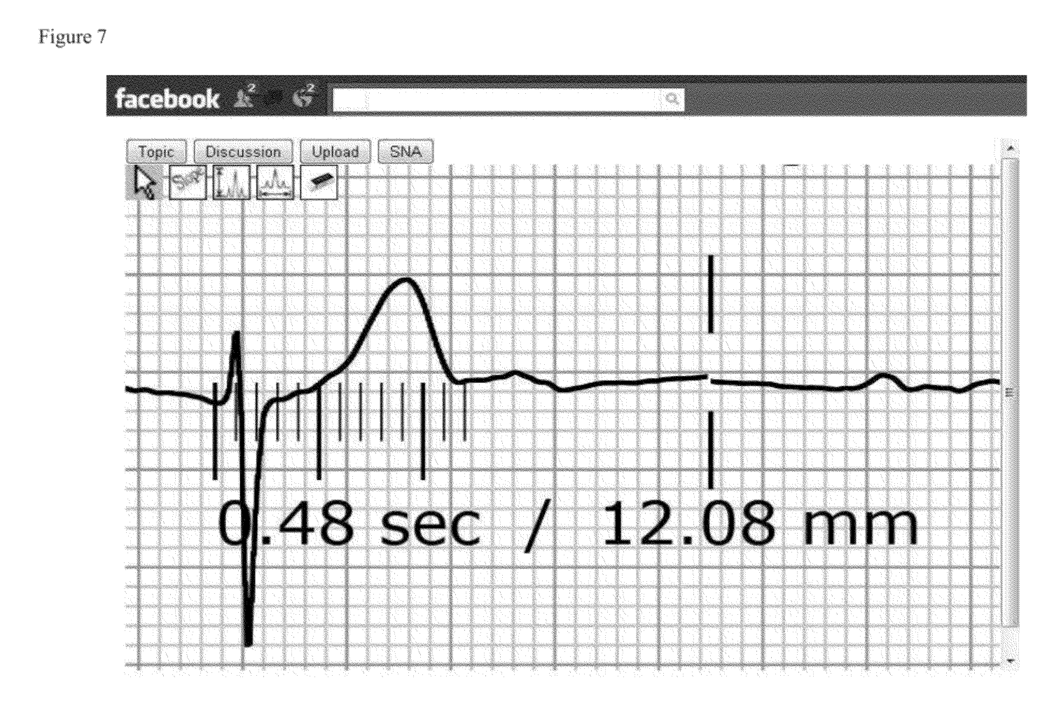

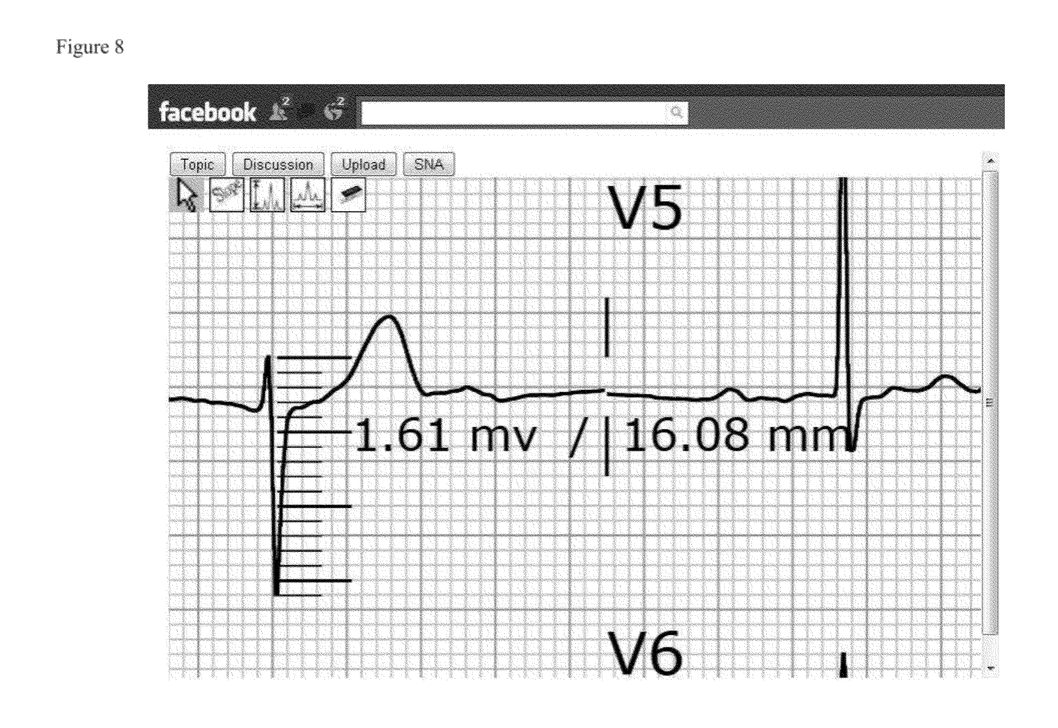

In the measurement aspect, as shown on the left-up side of FIG. 3, there was provided with a function button row, and the whole drawing paper could be moved by a cursor icon 110. The drawing paper could be zoomed-in or zoomed-out by rolling the wheel of the mouse up or down, as shown in FIG. 4 or FIG. 5. When measuring, the function of a slop measuring icon 120 was to calculate the slope. When clicking the wave by the mouse, the system would calculate the slope of the point clicked by the mouse, as shown in FIG. 6. The horizontal motion speed of wave shape was measured by a horizontal measuring icon 130, as shown in FIG. 7. On the contrary, the vertical grid number and the jumping range of the wave were measured by the vertical measuring icon 140, as shown in FIG. 8. When the value displayed on the frame was too much to be read, or was not easy to be measured, a cleaning icon 150 could be used to clean the frame to continue other operations.

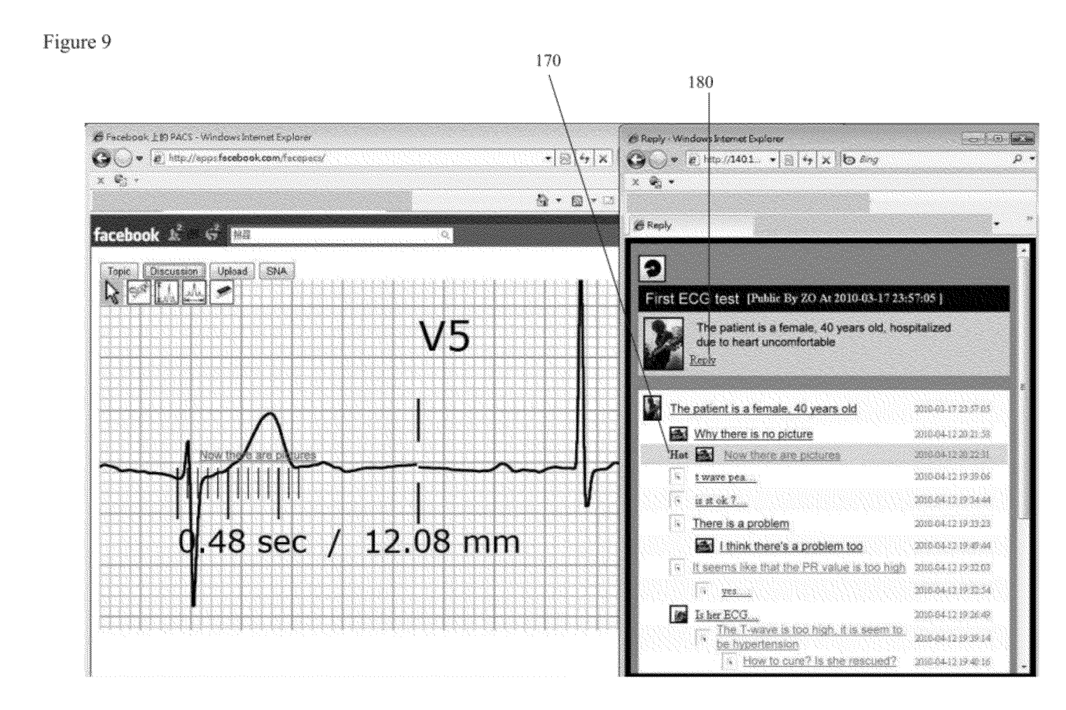

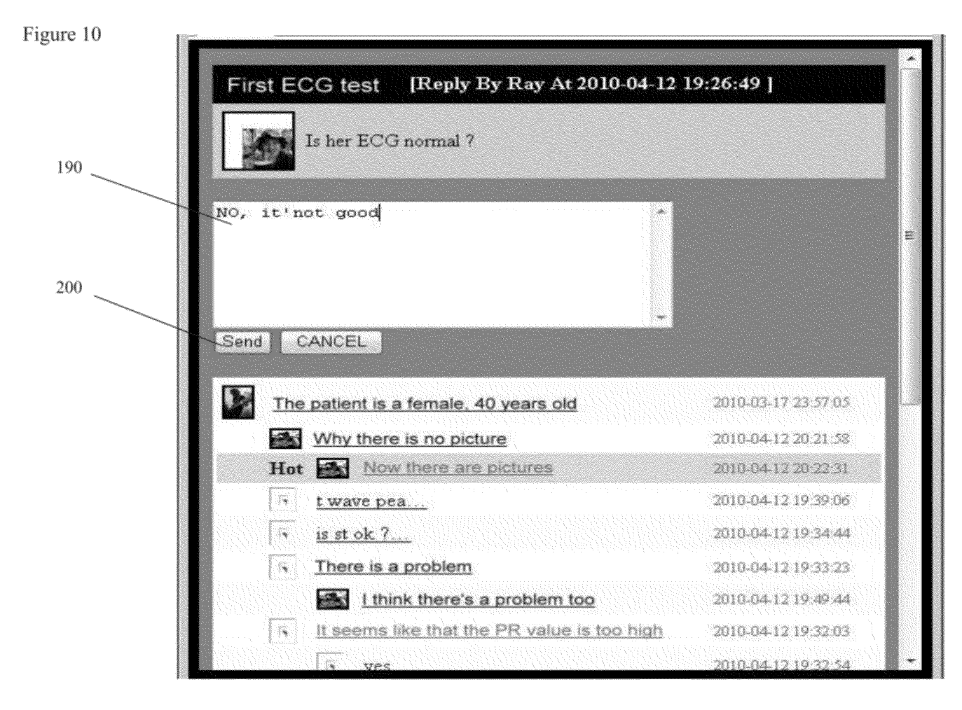

In the operating interface of the present invention, users could click a discussion icon 160 as shown on left-up the FIG. 3 to connect the discussing forum. The discussing forum was shown as FIG. 9. In the discussing forum, the discussing forum was presented hierarchically the discussion content of all users and updated every 10 minutes, and the on-line discussing situation could be viewed immediately. The latest data was painted in a grid matrix, and a “hot” icon 170 would be shown before the latest data so as to facilitate users to find the position of the latest data. When users wanted to know some data, they could click the data, and content of the data would be displayed on the top of the frame. If users wanted to reply, users could click a “reply” icon 180 displayed under the complete data, and the frame shown in FIG. 10 would be displayed. A reply box was displayed under the content, and users could enter words to be replied in the dialog box and then click “send” icon 200.

An “SNA” icon 210 shown on the top of FIG. 3 was used to analyze the social network position of each user in said discussing forum. The social network analysis software used the analysis tool (NodeXL software), and users had to install EXECEL 2007 and NodeXL so as to execute the network analysis successfully.

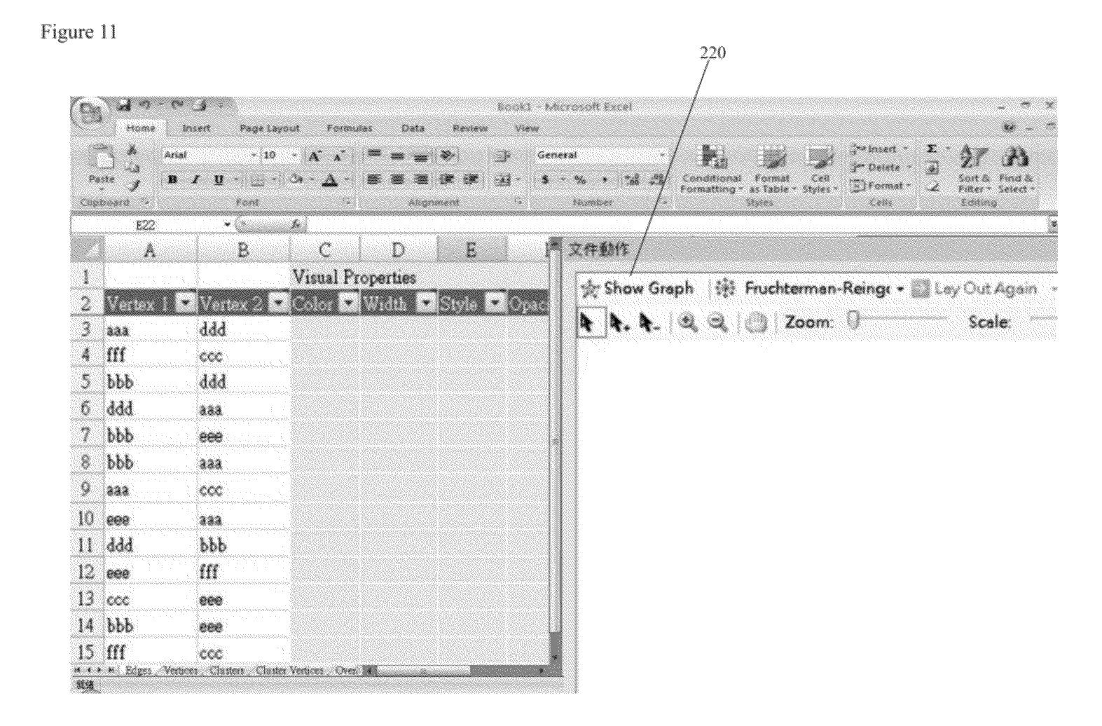

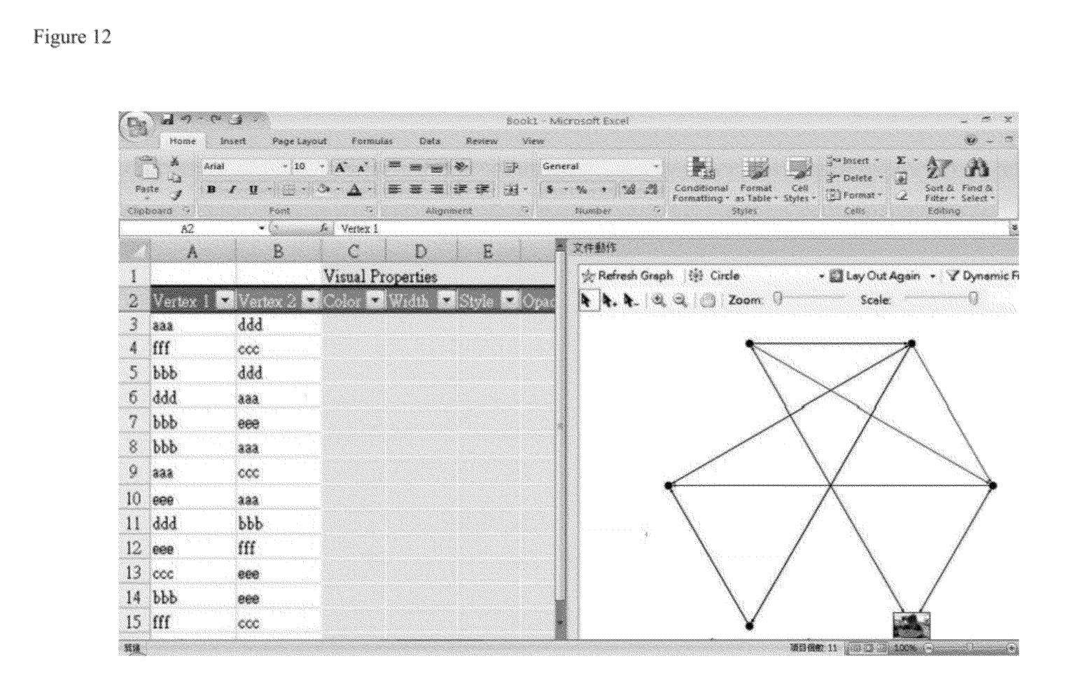

The present invention automatically transformed the data into excel for users to download, and users opened the files after downloading as shown in FIG. 11. After clicking a “Show Graph” icon 220, the NodeXL software would draw the social network figure of the topic as show in FIG. 12.

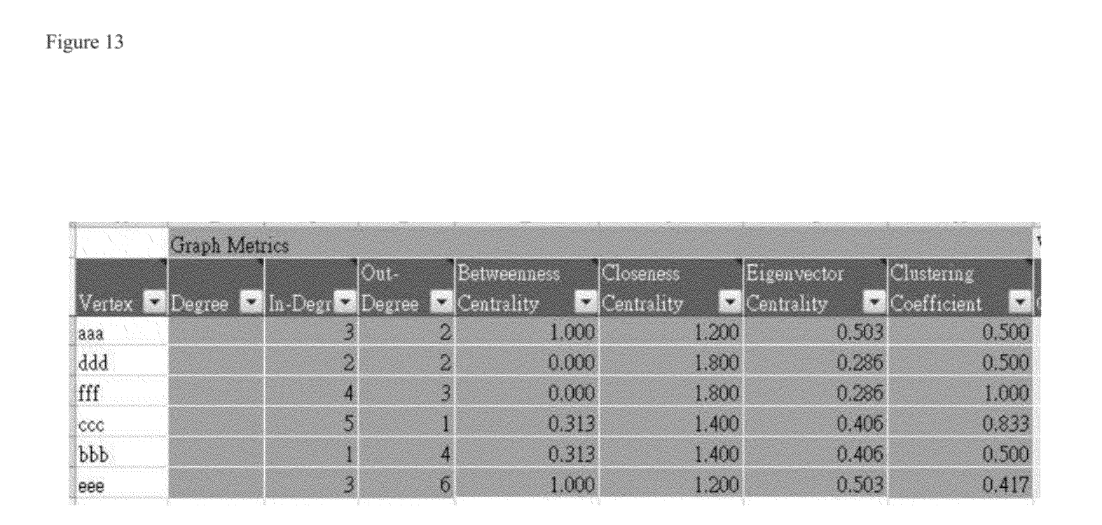

The system of the present invention could present position of users by pictures, so as to let users find their position clearly and quickly. In addition, when executing the social network analysis, the “Graph Metrics” option could be clicked by NodeXL, and users could click the items of the wanted analysis in the dialog box and then click “Compute Metrics”, and the tab in “Vertices” would automatically compute the number of each user as shown in FIG. 13.

Teachers could raise students' enthusiasm through the E-learning. Via the network analysis, teachers could also understand students' learning situation and give them appropriate help and counseling, so as to further raise the learning performance. It is a kind of mutually beneficial learning.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A 12-lead ECG online-learning system, comprising:
a processing server with a plug-in browser for receiving electrocardiogram-related data and eliminating noise accompanied in the electrocardiogram-related data;
a learning database apparatus for storing the electrocardiogram-related data; and
a learning network server for accessing the electrocardiogram-related data via network communication.

2. The 12-lead ECG online-learning system of claim 1, wherein the plug-in browser of the processing server is a Microsoft Silverlight browser.

3. The 12-lead ECG online-learning system of claim 1, further comprising an electrocardiogram managing system for selecting the electrocardiogram-related data with exploratory or meaningfulness, and then transferring the same to the Microsoft Silverlight browser.

4. The 12-lead ECG online-learning system of claim 1, further comprising a community website, wherein a user uses the community website to log in the learning network server, and the community website comprises a website interface.

5. The 12-lead ECG online-learning system of claim 4, wherein the community website is Facebook.

6. The 12-lead ECG online-learning system of claim 1, wherein the electrocardiogram-related data is an electrocardiogram or electrocardiogram-related information.

7. The 12-lead ECG online-learning system of claim 6, wherein a format of the electrocardiogram-related data is an XAML format.

8. The 12-lead ECG online-learning system of claim 1, wherein the learning network server transfers the electrocardiogram-related data through the electrocardiogram managing system or the website interface.

9. The 12-lead ECG online-learning system of claim 4, wherein the user is a teacher, a student, a clinical staff or a patient.

10. The 12-lead ECG online-learning system of claim 4, further comprising a horizontal tool, a vertical tool, a slope tool or a cleaning tool of the website interface to observe the electrocardiogram-related data.

11. The 12-lead ECG online-learning system of claim 1, further comprising a social network analyzing utility software for analyzing the electrocardiogram-related data.

12. The 12-lead ECG online-learning system of claim 11, wherein the social network analyzing utility software is NodeXL, and the social network analyzing utility software is incorporated with an EXECEL 2007 software to execute analysis of the electrocardiogram-related data.
